(19) United States
(12) Patent Application Publication
(10) Pub. No.: US 2008/0083492 A1
(43) Pub. Date: Apr. 10, 2008

(54) PROFILE OF RECYCLED PLASTIC AGGLUTINATED WITH NATURAL FIBERS AND REINFORCED WITH RIGID RODS AND THE PROCESS OF PRODUCING SAID PROFILE

(76) Inventor: Andre Alexandre Ferdinad De Reynier, Ipeuna (BR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/755,257

(22) Filed: May 30, 2007

(30) Foreign Application Priority Data
Oct. 10, 2006 (BR) PI 0604442-5

(51) Int. Cl. B32B 38/00

(52) U.S. Cl. 156/281; 52/649.2

(57) ABSTRACT

A profile of recycled plastic agglutinated with natural fibers and reinforced with rigid rods in conjunction with a process producing the said profile. The profile composed of a geometric shape predetermined by its applied use which could be as a profile for a signpost, for a utility pole crossarm, for a beam, for civil construction use, for a fence post or for a marine piling. The profile is manufactured from a thermoplastic mass and a natural fiber by an extrusion process, where the recycled thermoplastic is agglutinated with the natural fiber and then is coupled in predetermined points, preferably close to its borders, with rigid rods distributed in parallel alignment to the longitudinal axis of the profile. The process to manufacture the profiles incorporates an important device of counter weight in the extrusion process precluding the formation of air bubbles in the mass.

### RELATED APPLICATION

The present application claims priority to Brazilian Application No. PI 0604442-5 filed Oct. 10, 2006, which is incorporated herein in its entirety by reference.

### BACKGROUND OF THE INVENTION

1. Field of the Invention

The present invention relates to recycled plastic agglutinated materials.

2. Description of the Prior Art

The use of natural fibers in the construction of various products has increased recently due to a series of advantages which include low cost and raw material abundance, among others. The use of sugarcane fibers in particular has been a subject of research in various countries and the present invention is a result of this type of research.

As a general rule, sugarcane fibers are mainly used in the automobile industry, in civil construction, in the manufacturing of thermoplastic injected parts, as bulking agents in thermo molded parts (i.e., Bakelite-TRADEMARK), wood-stock items and in chip boards.

Natural sugarcane fibers become interesting when associated with materials such as polystyrene, polypropylene, polyethylene, polyurethane, and resins, etc., due to the following characteristics: mechanical properties, low density, high flash point, and low cost.

Successful experiments have been conducted with the production of pellets made with either virgin or recycled polypropylene and natural sugarcane fibers and then used for the injection of plastic parts. Experiments and testing were conducted using approximately 30% fiber material on an industrial sized scale.

Another aspect to be considered is that parts made using natural sugarcane fibers are also recyclable, diminishing the use of non-renewable raw materials such as petroleum, and in so doing help the environment by consuming waste residues.

### SUMMARY OF THE INVENTION

The present invention seeks to provide a profile of recycled plastic agglutinated with natural fibers and reinforced with rigid rods in conjunction with the process producing the said profile. The profiles in conjunction with the manufacturing process are a result of an unprecedented invention for the production of a unique material with unusual characteristics having varied applications in civil construction, the manufacturing of posts and sign poles, utility pole crossarms, beams, and a series of other products. These are all possible due to the final characteristics of the product, which includes good physical and mechanical resistance combined with a low production cost and the use of a recycled plastic raw material. The association of natural fibers with plastic produces a new dimension of resistant products that have a low production cost and could be considered ecologically correct. The use of natural fibers found in abundance in nature is a present day relevant factor. Among the natural fibers utilized, we can mention sugarcane bagasse, sisal hemp, coconut fiber, and similar materials.

In the present invention a mixture of natural fibers, particularly those of sugarcane fibers, together with the mentioned plastic materials associated with a rigid component, preferably in the form of a rod, could make products with a wide scale of application and express advantages for various segments such as civil construction, roadside sign manufacturing (where there is an eventual impact factor), fence posts, marine pilings, utility pole crossarms, beams, and other applications that could possibly use this invention. Therefore, in the present invention it is formed of a recycled plastic profile obtained from a material agglutinated with natural fibers with rigid reinforcing, usually fiberglass, although alternatively this reinforcing can be metal. The present invention also includes the overall process to produce the profile.

The natural fibers used are preferentially those of sugarcane fibers bagasse; however coconut and sisal hemp fibers are already being studied and deserve consideration.

The studies indicate that technically, the addition of up to 50% of natural fiber is effective in making the profiles, keeping in mind that the variable level of fibers alters the parameters of the process and the characteristics of the final product.

In some cases, such as in the case of signposts, subject to impacts by vehicles or other events, which may culminate in the eventual breakup of the signposts in question, the use of rigid fiberglass rods is desirable according to the traffic authorities. With the use of steel corrugated rods, these posts are usually only bent by impact, causing more injuries to the occupants of the motor vehicles.

Other applications of the profiles with supports in fiberglass, where impact destruction is desirable could be extremely useful in diverse segments that might be dealing with the same type of problems.

However, there are uses for supports in corrugated steel, where this strength is most efficient and desirable.

The present invention seeks to provide a profile of recycled plastic with agglutinated natural fibers reinforced with rigid rods made from a thermoplastic material with natural fibers manufactured by the extrusion process, in a geometric shape having borders, selected from the group consisting of: a signpost, a utility pole crossarm, a beam, a civil construction use device, a fence post and a marine piling. The profile includes a recycled thermoplastic mass agglutinated with the natural fibers and coupled in a predetermined point with rigid rods, the rods distributed in parallel alignment to a longitudinal axis of the profile.

The present invention also seeks to provide a process for manufacturing the profile discussed above, the process including the steps of: (a) washing the thermoplastic material with any suitable material known in the art; completely removing any attached product; (b) drying completely the thermoplastic material with any suitable drying process for a suitable period of time; (c) grounding the thermoplastic material in conventional grinders; (d) adding a suitable amount of the natural fiber and a suitable amount of an agglutination resin to the thermoplastic material, mixing the thermoplastic material in a mixer operating at a predetermined rotation suitable for the quantity of mass to be mixed; (e) feeding the mixed thermoplastic material to an extruder, the extruder having interchangeable molds according to the profile to be produced, the molds having a covering, a frontal and a posterior part, and internal guides for the inclusion of the rigid rods; and counter weight on the frontal part for avoiding the formation of air bubbles in the mass, and (f) cooling the mold in a cooling bath with water or any other suitable liquid, for a suitable time and temperature necessary for opening the mold covering and extracting the extracted piece coupled with the rigid rods.

The process permits the formation of the profile in a simple manner, using the technique of recycled thermoplastic extrusion with the inclusion of a counter weight device during the process. This receives the rigid rods in a manner that due to a movement in the opposite direction during the filling process, air bubbles are not formed in the interior of the mass.

### BRIEF DESCRIPTION OF THE DRAWINGS

FIG. 1 is a square profile in detail with rigid rods.

FIG. 2 is a rigid rod in fiberglass.

FIG. 3 is a profile design in another geometric configuration (for illustrative reasons) along with rigid metallic rods.

FIG. 4 is a process flow for the manufacturing of a profile starting with the mixture and agglutination of the mass until the completion of the product.

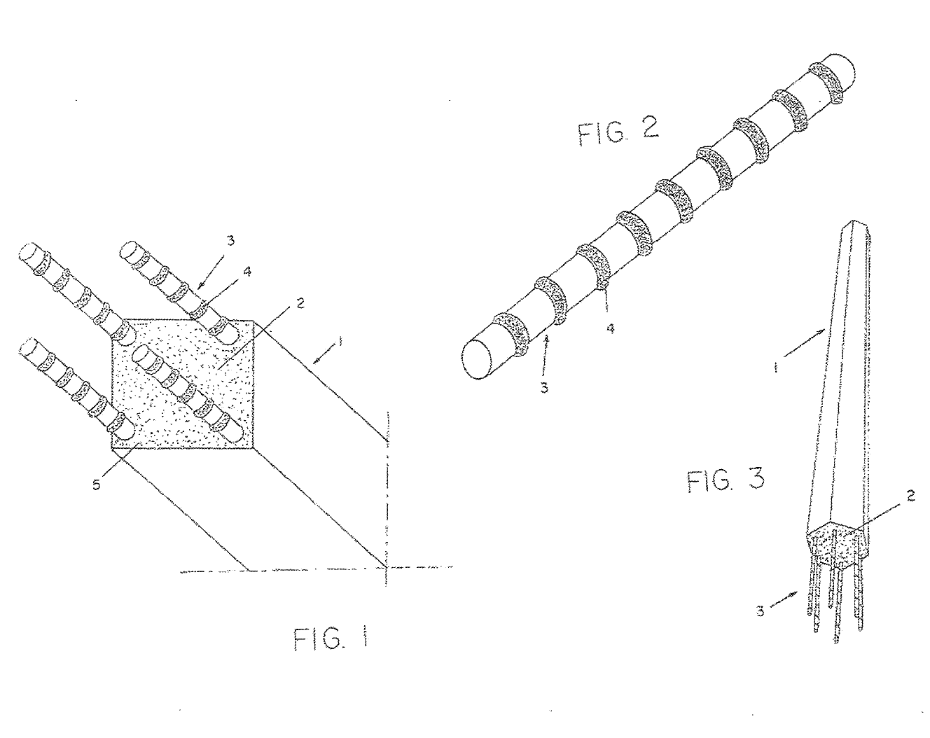

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that, numerous changes may be made without straying from the scope of the present invention.

The present invention includes a recycled plastic profile reinforced with rigid rods obtained by means of an extrusion process, where the profile (1) in reference is of a geometric form predetermined by its eventual application, thus this form is variable according to the project and the desired product.

The profile (1) is formed by a thermoplastic mass with natural fibers obtained during an extrusion process which incorporates recycled plastic with natural fibers (2) and in predetermined points, preferentially near the borders, rigid rods (3) that are distributed in a parallel manner along the longitudinal axis of the profile (1).

The material used to obtain the profile (1) is preferably polystyrene and optionally polypropylene or even polyethylene, polyurethane or some resins; however other materials with similar properties may be used in the same manner as stipulated in the present patent application.

The natural fiber used is preferentially composed of sugarcane bagasse as it is viable and in research phase the use of other fibers such as those from sisal hemp and coconuts which have been shown to have efficacy. The presence of natural fiber in the final product can be up to 50% of the total volume by mass of the product.

The rigid rods (3) are preferentially cylindrical supports made of fiberglass, technically sized and protruding externally in a helicoidally manner along the whole length (4) with the aim of increasing the mechanical resistance of the piece (3). These supports are inserted during the manufacturing or extrusion process between the hardened thermoplastic material that contains the natural fiber. An important characteristic of the referred to profile, is that due to the manufacturing process there are no air bubbles formed on the lateral surfaces of the profile (1), next to the borders (5) due to the extrusion method.

The manufacturing process of the profile includes the following steps of:

a) washing of the thermoplastic material (for example, polystyrene, PET, or others which is performed with traditional materials used for this process, the purpose of this being the complete removal of whatever product may have been attached there;

b) drying of the thermoplastic material, this process can be natural, by exposure to direct sunlight, forced heated air, or plain storage—this procedure does not have a definite time period and depends upon variables that are determined case-by-case depending upon the drying process used. It is necessary that the thermoplastic material be completely dry for the steps that are to follow. In the case of natural drying the time period can be affected by the volume of plastic and any other external conditions;

c) the thermoplastic material is ground in conventional grinders;

d) in this step the material is mixed in a mixer (6) with a predetermined rotation that depends upon the volume of the mass to be mixed and it is during this mixing that the natural fibers are added, preferentially sugarcane bagasse but also coconut and sisal hemp fibers can be used. These natural fibers can be added up to a maximum of 50% of the total mass volume, usually with fibers varying between zero mm and 25 mm in length. In order to accelerate agglutination, an agglutinating resin is added in this step;

e) the mass obtained in the previous steps is added to an extruder (7) which may have interchangeable molds (8) according to the profiles being produced; these molds (8) have internal guides for the inclusion of rigid rods (3) in the mold itself, the rods being of fiberglass or steel. This extruder has a particular characteristic, which includes the use of a counter weight device (9), which works in the front of the mold (8) breaking the movement during the extrusion because of the counter weight (9) which causes a reverse movement during the filling and thus eliminating air bubble formation in the mass. The weight (10) of the counter weight device (9) is variable and regulated in accordance with the consistency of the desired mass; and

f) finally in this step the mold (8) is taken to a cooling bath (11) of water or another liquid with similar or superior properties, the cooling time being determined by the temperature necessary to be able to extract the mold covering (8) so that the extracted piece (12) already with its rigid rods can be dried (3).

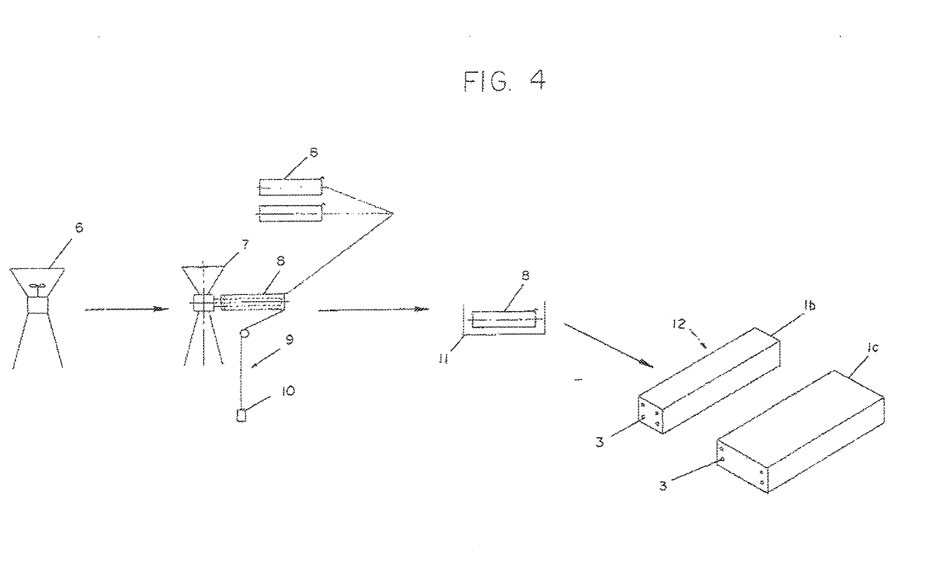

FIG. 4 shows as example two models of profiles (1) the first (1b) being indicated for signposts and utility pole crossarms among other uses and the second (1c) is an example of a beam profile.

It should be understood that the preferred embodiments mentioned here are merely illustrative of the present invention. Numerous variations in design and use of the present invention may be contemplated in view of the following claims without straying from the intended scope and field of the invention herein disclosed.

Having thus described the invention, what is claimed as new and secured by Letters Patent is:

1. A profile of recycled plastic with agglutinated natural fibers reinforced with rigid rods manufactured by an extrusion process, wherein the profile includes a recycled thermoplastic mass agglutinated with the natural fibers and coupled in a predetermined point with rigid rods, the rigid rods distributed in a parallel alignment to a longitudinal axis of the profile.

2. The profile of recycled plastic with agglutinated natural fibers reinforced with rigid rods according to claim 1, wherein the profile is manufactured in a geometric shape, having borders, the shape selected from a group consisting of: a signpost, a utility pole crossarm, a beam, a civil construction use device, a fence post and a marine piling.

3. The profile of recycled plastic with agglutinated natural fibers reinforced with rigid rods according to claim 1, wherein the natural fiber is selected from a group consisting of: sugar-cane bagasse, coconut fiber and sisal hemp.

4. The profile of recycled plastic with agglutinated natural fibers reinforced with rigid rods according to claim 1, wherein the recycled thermoplastic mass is selected from a group consisting of: polystyrene, polypropylene, polyethylene, polyurethane and suitable resins.

5. The profile of recycled plastic with agglutinated natural fibers reinforced with rigid rods according to claim 1, wherein the natural fibers at a maximum amount of 50% of the total mass.

6. The profile of recycled plastic with agglutinated natural fibers reinforced with rigid rods according to claim 1, wherein material for the rigid rods is selected from a group consisting of:
fiberglass and corrugated metal.

7. The profile of recycled plastic with agglutinated natural fibers reinforced with rigid rods according to claim 1, wherein the rigid rods are cylindrical rods with lengthwise external protruding projections oriented helicoidally.

8. The profile of recycled plastic with agglutinated natural fibers reinforced with rigid rods according to claim 1, wherein the rigid rods are inserted during the manufacturing or extrusion process in-between the thermoplastic mass containing the natural fiber.

9. The profile of recycled plastic with agglutinated natural fibers reinforced with rigid rods according to claim 1, wherein the recycled thermoplastic mass agglutinated with the natural fibers is coupled adjacent to the borders of the profile.

10. The profile of recycled plastic with agglutinated natural fibers reinforced with rigid rods according to claim 1, wherein the areas adjacent to the borders of the profile are completely void of bubbles.

11. A process for manufacturing the profile of claim 1, the process including the steps of:
(a) washing the thermoplastic mass with any suitable material, completely removing any attached product;
(b) drying completely the thermoplastic mass with any suitable drying process for a suitable period of time;
(c) grounding the thermoplastic mass in conventional grinders;
(d) adding a suitable amount of the natural fiber and a suitable amount of an agglutination resin to the thermoplastic mass, mixing the thermoplastic mass in a mixer operating at a predetermined rotation suitable for the quantity of mass to be mixed;
(e) feeding the mixed thermoplastic mass to an extruder, the extruder having interchangeable molds according to the profile to be produced, the molds having a covering, a frontal and a posterior region, and internal guides for the inclusion of the rigid rods; and having a counter weight on the frontal region for avoiding the formation of air bubbles in the thermoplastic mass; and
(f) cooling the mold in a cooling bath with water or any other suitable liquid, for a suitable time and temperature necessary for opening the mold covering and extracting an extracted piece coupled with the rigid rods.

12. The process of claim 11, wherein the weight of the counter weight is determined according to the consistency of the thermoplastic mass to be produced.

13. The process of claim 11, wherein the drying method is selected from a group consisting of: natural drying process, exposition to direct sunlight, feeding of forced heated air, and storage.

14. The process of claim 11, wherein the natural fiber is selected from a group consisting of: sugar-cane bagasse, coconut fiber and sisal hemp.

15. The process of claim 11, wherein the profile includes the natural fibers at a maximum amount of 50% of the total mass.

16. The process of claim 11, wherein the profile includes natural fibers of a maximum of 25 mm in length.

17. The process of claim 11, wherein the thermoplastic mass is selected from a group consisting of: polystyrene, polypropylene, polyethylene, polyurethane and suitable resins.
